(19) United States
(12) Patent Application Publication
(10) Pub. No.: US 2002/0053295 A1
(43) Pub. Date: May 9, 2002

(54) Apparatus for image formation on cylindrical surfaces in printing machines

(76) Inventor: Arndt Jentzsch, Coswig (DE)

Correspondence Address: GABRIEL P. KATONA, GOODWIN PROCTER L.L.P., 599 LEXINGTON AVENUE, 40TH FLOOR, NEW YORK, NY, 10022, US

(21) Appl. No.: 09/948,009

(22) Filed: Sep. 6, 2001

(30) Foreign Application Priority Data
Sep. 9, 2000 (DE) 100 45 682.0

(51) Int. Cl. B41F 7/02

(52) U.S. Cl. 101/217

(57) ABSTRACT

The invention relates to an apparatus for image formation on cylindrical surfaces of printing machines.

Task of the invention is to establish a compact image formation unit with a broad application range regarding its usage, the sequence in time and variation in time of the process steps.

The task is solved according to the invention by processing units mounted on slides movable separately on a common cross bar. Each slide carries at least one processing unit. The cross bar is located in the godet between plate cylinder and blanket cylinder.

### FIELD OF INVENTION

The invention relates to an apparatus for image formation on cylindrical surfaces in printing machines consisting of multiple processing units arranged side by side and allocated to the plate cylinder of the printing machine. The processing units can me moved axially to the plate cylinder.

### BACKGROUND OF INVENTION

A printing machine with a printing unit having a gapless image cylinder, which is coated with a dryable polymer by a direct image formation process, is known through DE 19612927 A 1. The surface characteristic of this polymer layer on the image cylinder is changed completely or partially by a selective laser beam in order to changes its affinity to printing ink. The image cylinder is used instead a plate cylinder in a conventional offset press either in wet offset or dry offset printing. The image cylinder is cleaned from the image carrying layer after finishing printing. The layer must not be removed completely. The radiation source, the coating unit and the drying unit are arranged side by side on a spindle drive and moved by the spindle drive over the width of the cylindrical surface to be imaged. The cleaning unit is mounted separately.

Disadvantage of this solution is the missing processing space caused by the number and fixed allocation of the processing units. The versatility of this apparatus is insufficient for many applications.

### SUMMARY DESCRIPTION OF INVENTION

Task of the invention is to establish a compact image formation unit with a broad application range regarding its usage, the sequence in time and variation in time of the process steps.

The task is solved according to the invention by processing units mounted on slides movable separately on a common cross bar. Each slide carries at least one processing unit. The cross bar is located in the godet between plate cylinder and blanket cylinder.

The advantage of this invention is the variability of using the single process steps. It is also possible to adapt the processing intensity of the single processing units to the process requirements by their time effecting the surface.

### BRIEF DESCRIPTION OF THE DRAWINGS

The invention is described below in greater detail by an embodiment of the invention, by reference being had to the drawing, wherein:

FIG. 1: Schematic of the roller and cylinder scheme of a printing unit in a printing press with the invented apparatus in an embodiment with mounting on a cross bar

FIG. 2: Schematic of the invented apparatus in an embodiment with mounting on a spindle drive

FIG. 3: Schematic of the invented apparatus in an embodiment with mounting on a linear motor drive

FIG. 4: Schematic of the roller and cylinder scheme of a printing unit in a printing press with the invent ed apparatus in an embodiment with mounting on two cross bars

### DETAILED DESCRIPTION

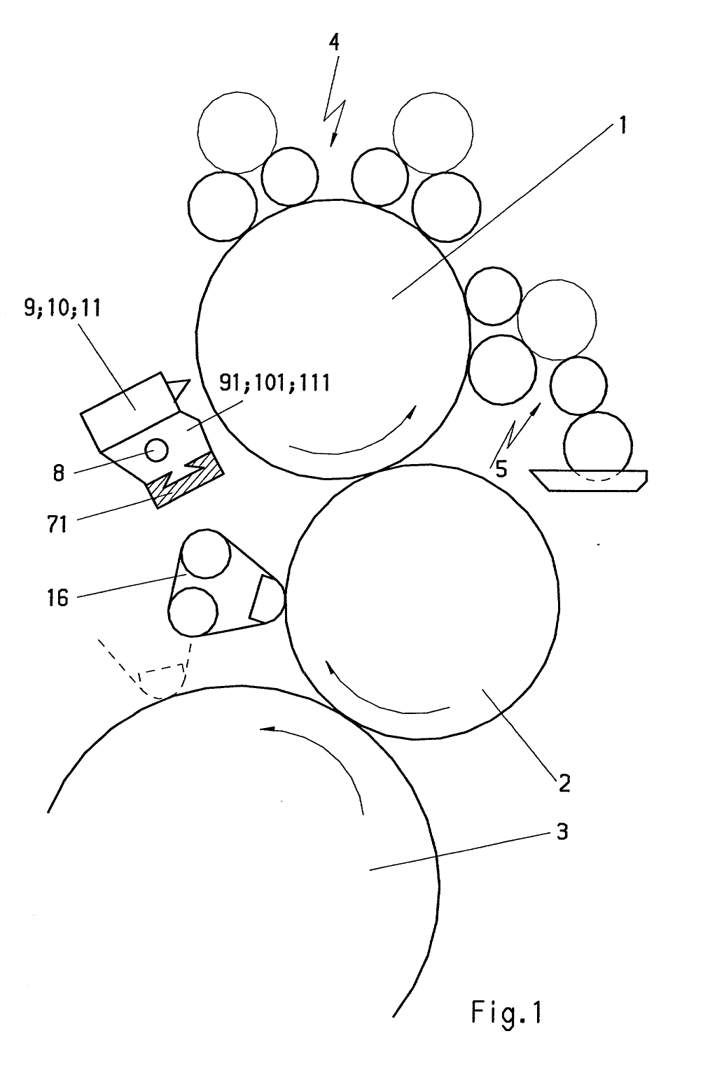

FIG. 1 shows the printing unit of a multi-color sheet fed offset press. The printing unit contains the impression cylinder 3 carrying the sheet and as the image transferring cylinders the plate cylinder 1 and the blanket cylinder 2.

An inking unit 4 and a dampening unit 5 is allocated to each plate cylinder 1. The plate cylinder 1 can also carry a here not shown printing form.

A cross bar 71 is located in the area of the godet between the plate cylinder 1 and the blanket cylinder 2. The cross bar is located in a manner that other equipment in this area for instance the cleaning unit 16 are not obstructed in their operational space. The cross bar 71 carries the processing units 9, 10 and 11 for image formation on the surface of the plate cylinder 1 respectively a printing form mounted on the plate cylinder 1.

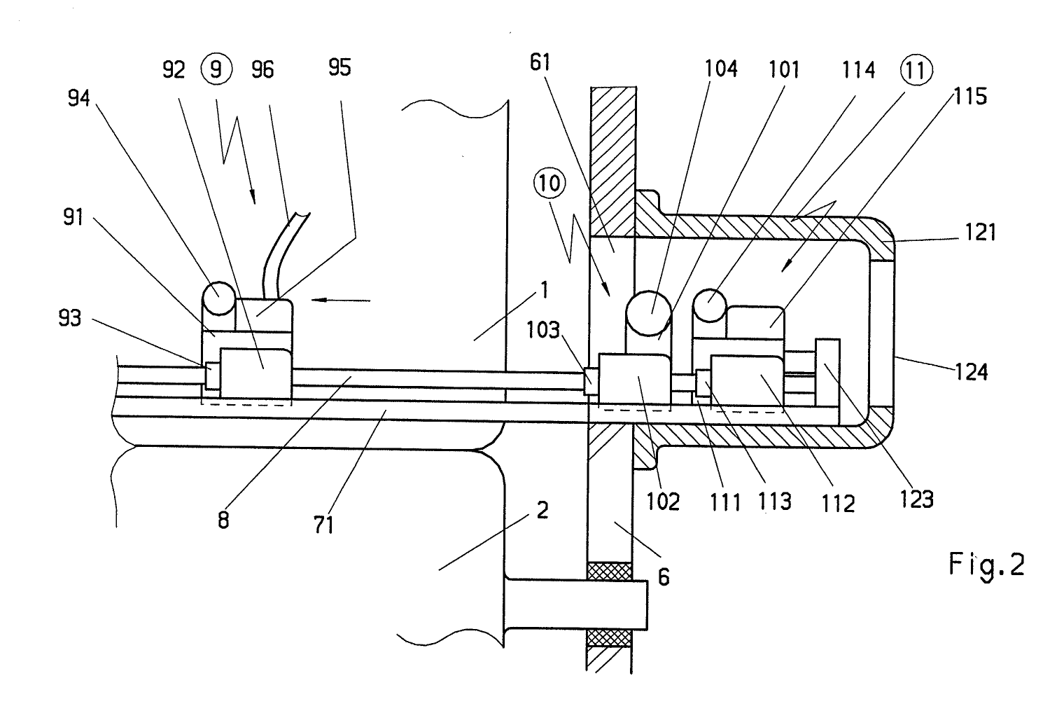

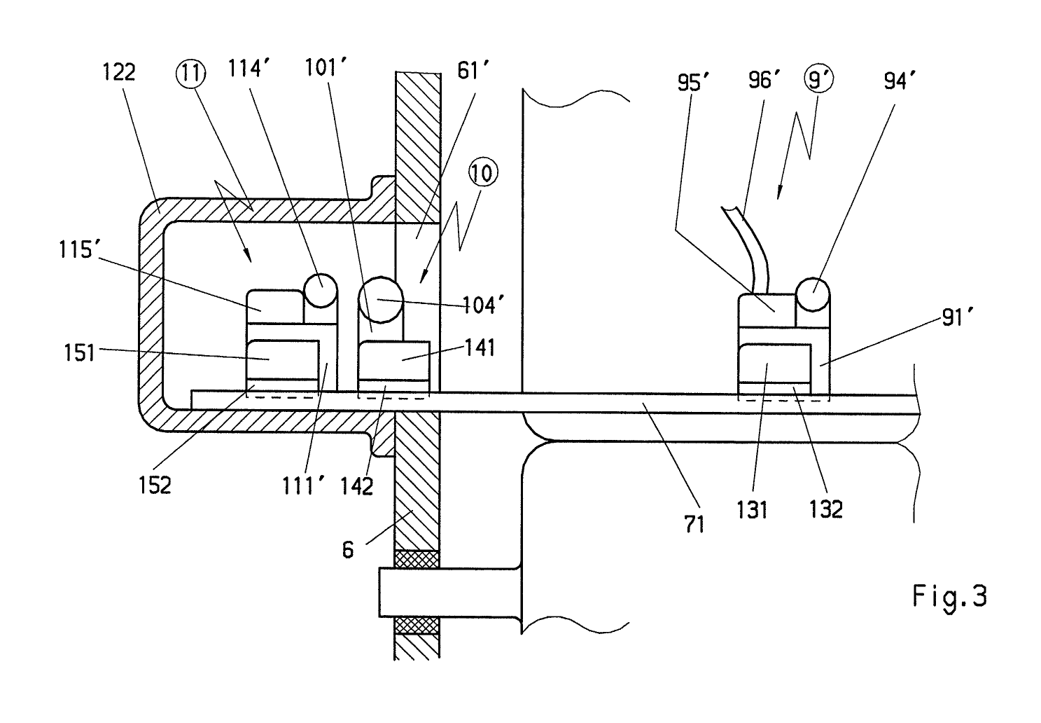

FIG. 2 shows the details of this embodiment. The cross bar 71 is mounted in the side frame 6 of the printing machine. The cross bar 71 stretches parallel to the surface of the plate cylinder 1 over the entire width of the printing press (see also FIG. 3). Parallel to the cross bar 71 is the spindle drive 8 is supported non-rotating in the pillow block 123.

The cross bar 71 and the spindle 8 are extending over the side frame 6. Therefore the side frame 6 has a cut out 61 covered by housing 121. The housing 121 is accessible by a coverable opening 124.

The first processing unit 9 is mounted on a slide 91. This slide 91 is connected with a first motor 92 driving a first spindle 93. The first spindle 93 is in an operational connection to the fixed spindle 8. The first slide 91 carries also the erasing unit with an erasing head 94 and a suction 95 with a suction hose 96. The erasing head 94 is embodied as a high-energy laser. The erasing head 94 must be located before the suction 95 in the moving direction of the first slide 91 (see arrow in FIG. 2).

The first processing unit 9 is followed by the second processing unit 10 in the moving direction of the processing units 9, 10 and 11. This unit is also mounted on a slide 101 and has a motor 102 and a spindle 103 of the same configuration. The slide 101 carries here the coating unit 104. The coating unit is embodied as an ink jet printing head.

The next and in this embodiment last processing unit is in the processing sequence the third processing unit 11. It has as described above analogue to the processing units 9 and 11a motor 112 and a spindle 113. The slide 111 carries an image formation unit and a fixation unit 115.

The FIGS. 1 and 2 do not show the supply cables and supply hoses to simplify these representations.

The operation of the above-described embodiment is explained in the following.

The three processing units 9, 10 and 11 are in its parking position on the side frame 6 at the beginning of the image formation process. They are partially or completely covered by the housing 121.

The first processing unit 9 moves in the arrow direction to the plate cylinder 1 for image formation. The motor 92 starts its operation and rotates the spindle 93. The slide 91 is moved in the designated direction because the spindle 8 is non-rotating supported. The plate cylinder 1 rotates with an appropriate speed for this process.

The erasing head 94 is activated if the plate cylinder 94 is reached. The laser of the erasing head 94 erases the image information respectively removes the image layer of the preceding printing job from the plate cylinder 1. The suction 95 takes the loosened particles and removes them from the printing machine. The first processing unit reaches its park position at the opposite side of the side frame 6 after the complete removal of the old image layer. A housing 122 analogue to the housing 121 is provided for this purpose.

The so prepared surface of the plate cylinder 1 is now coated by the coating unit 104 in the second processing unit 10 with a layer to be imaged. The movement of this second processing unit 10 realized is analogue to the first processing unit 9. This process starts typically immediately after removal of the old layer respectively the old image information. The second processing unit 10 takes its park position also on the opposite side after finishing coating.

The third processing unit 11 is now started as the last processing step after the required hardening time of the applied layer passed. The third processing unit 11 moves in the described manner over the surface of the plate cylinder 1. The actual image information is applied by the laser of the imaging unit 114 and hardened by the fixation unit 115 during this movement.

The processing units 9, 10 and 11 take their park positions on the opposite side after image formation. The printing process can now start. It is advantageous to move the processing units 9, 10 and 11 back to their original position before printing. The speed of this movement is a multiple of the processing speed. The processing units 9, 10 and 11 can moved one after the other or together in complex.

The embodiment described above is only one possible embodiment. It is for instance also possible to insert or to integrate an additional processing unit after the second processing unit 10 to harden the layer if technically required. A unit for cleaning and developing can be also inserted after the third processing unit 11.

FIG. 3 shows the parking positions of the processing units after image formation. The FIG. 3 shows also another embodiment of the invention. The processing units 9′, 10′ and 11′ are equipped with linear motors 131, 141 and 151. They are connected to the cross bar 71 through the drive members 132, 142 and 152. The operation is the same as described above.

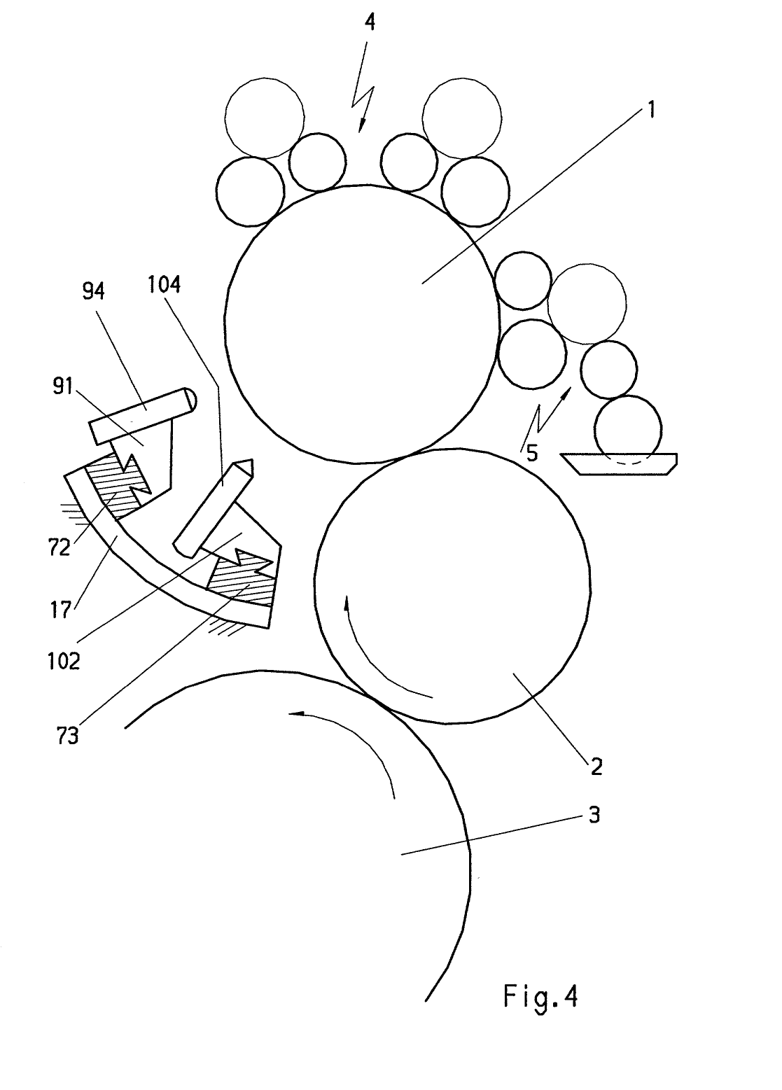

FIG. 4 shows an embodiment with two cross bars 72 and 73. This arrangement has the advantage that in embodiments with more processing units these units can be distributed between the two crossbars 72 and 73. This results in better space distributions and more room in the parking positions in the adjacency of the side frame 6. With it the processing units can be driven either by linear motors 131, 141 and 151 or with motors 92, 102 and 112.

We claim:

1. Apparatus for image formation on cylindrical surfaces in printing machines consisting of multiple processing units arranged side by side, allocated to the plate cylinder of the printing machine and axially movable to this plate cylinder, whereby these processing units are arranged on slides with at least one processing unit per slide, and the slides separately moveable on a common cross bar.

2. Apparatus for image on cylindrical surfaces in printing machines consisting of multiple processing units arranged side by side, allocated to the plate cylinder of the printing machine and axially movable to this plate cylinder, whereby these processing units are arranged on slides with at least one processing unit per slide and the slides separately moveable on cross bars.

3. Apparatus for image formation on cylindrical surfaces in printing machines consisting of multiple processing units arranged side by side, allocated to the plate cylinder of the printing machine and axially movable to this plate cylinder, whereby these processing units are arranged on slides with at least one processing unit per slide, the slides separately moveable on cross bars and the cross bars are allocated in the godet between plate cylinder and blanket cylinder.

4. Apparatus for image formation on cylindrical surfaces in printing machines according to claim 1, whereby on both sides the parking positions for the processing units during printing are adjacent to the side frame.

5. Apparatus for image formation on cylindrical surfaces in printing machines according to claim 4, wherebyon both sides the parking positions for the processing units are within a housing allocated cut out o the side frame of the printing machine.

6. Apparatus for image formation on cylindrical surfaces in printing machines according to claim 1, wherebythe first slide carries an erasing head and a suction.

7. Apparatus for image formation on cylindrical surfaces in printing machines according to claim 6, wherebythe erasing head is a high energy laser.

8. Apparatus for image formation on cylindrical surfaces in printing machines according to claim 1, wherebythe second slide carries a coating unit.

9. Apparatus for image formation on cylindrical surfaces in printing machines according to claim 8, whereby the coating unit is an ink jet printing head.

10. Apparatus for image formation on cylindrical surfaces in printing machines according to claim 1, wherebythe third slide carries an imaging unit and a fixation unit.

11. Apparatus for image formation on cylindrical surfaces in printing machines according to claim 10, wherebythe imaging unit is a laser unit.

12. Apparatus for image formation on cylindrical surfaces in printing machines according to claim 1, whereby the slides are driven by linearmotors connected through drive members with the cross bar.

13. Apparatus formation on cylindrical surfaces in printing machines according to claim 1, whereby a fixed spindle is connected to the driven slides through spindle nuts allocated in these slides.
